(19) United States
(12) Patent Application Publication
(10) Pub. No.: US 2022/0358741 A1
(43) Pub. Date: Nov. 10, 2022

(54) METHOD AND APPARATUS FOR DETERMINING SKELETON DRIVE COEFFICIENT, ELECTRONIC DEVICE, AND READABLE STORAGE MEDIUM

(71) Applicant: BEIJING BAIDU NETCOM SCIENCE TECHNOLOGY CO., LTD., Beijing (CN)

(72) Inventor: Ruizhi CHEN, Beijing (CN)

(21) Appl. No.: 17/870,690

(22) Filed: Jul. 21, 2022

(30) Foreign Application Priority Data
Aug. 4, 2021 (CN) 202110892635.7

(51) Int. Cl. G06T 19/20; G06T 13/40

(52) U.S. Cl. CPC G06T 19/20; G06T 13/40; G06T 2219/2016

(57) ABSTRACT

Provided are a method and an apparatus for determining a skeletal driving coefficient, an electronic device, and a readable storage medium, and relates to the field of image processing technologies, and in particular, to the field of artificial intelligence or augmented reality technologies. A method includes driving a deformation, based on an initial skeletal driving coefficient, on an initial skin-skeleton model to obtain a first skinned skeleton model; and in response to a difference between the first skinned skeleton model and a target skinned skeleton model does not meet a threshold, performing at least one deformation on the first skinned skeleton model until a second skinned skeleton model, the difference between which model and the target skinned skeleton model meets the condition on the difference, is obtained, and obtaining at least one target skeletal driving coefficient used for driving the at least one deformation.

### CROSS REFERENCE TO RELATED APPLICATION

This application claims priority to Chinese Patent Application No. 2021108926357, filed on Aug. 4, 2021, the contents of which are hereby incorporated by reference in their entirety for all purposes.

### BACKGROUND

### Technical Field

The present disclosure relates to the field of image processing technologies, and in particular, to the field of artificial intelligence or augmented reality technologies. Specifically, the present disclosure relates to a method and an apparatus for determining a skeletal driving coefficient, an electronic device, and a readable storage medium.

### Description of the Related Art

Human faces are important and direct features for human beings to express their emotions and communicate on a daily basis. A 3D human face model with a sense of reality generated by a computer has gained a prospect of a wide application, and has become one of the most challenging issues in the fields such as computer graphics, computer vision, and artificial intelligence.

At present, in generation of a 3D human face model, usually, an electronic device sends a photo of a human face to a server, and the server generates a 3D human face model corresponding to the photo of the human face based on the blendshape technology, and obtains a plurality of blendshape coefficients used to generate the 3D human face model. Then, the server returns the blendshape coefficients to the electronic device, so that the electronic device can generate the 3D human face model based on the blendshape coefficients.

There is a relatively large data amount of the blendshape coefficients, and data transmission costs in sending the blendshape coefficients to the electronic device by the server is relatively high.

### BRIEF SUMMARY

The present disclosure provides a method and an apparatus for determining a skeletal driving coefficient, an electronic device, and a readable storage medium to solve at least one of the above defects.

According to a first aspect of the present disclosure, a method for determining a skeletal driving coefficient is provided, where the method includes:
driving a deformation, based on a pre-configured initial skeletal driving coefficient, on a pre-configured initial skin-skeleton model to obtain a first skinned skeleton model; and
in response to a difference between the first skinned skeleton model and a target skinned skeleton model does not meet a threshold condition on difference data, at least one deformation on the first skinned skeleton model until a second skinned skeleton model, the difference data between which model and the target skinned skeleton model meets the condition on difference data, is obtained, and obtaining at least one target skeletal driving coefficient used for driving the at least one deformation.

According to a second aspect of the present disclosure, a method for generating a human face model is provided, where the method includes:
receiving a target skeletal driving coefficient sent by a server, where the target skeletal driving coefficient is obtained after the server drives a deformation, based on a pre-configured initial skeletal driving coefficient, on a pre-configured initial skinned skeleton model to obtain a first skinned skeleton model, and performs at least one deformation on the first skinned skeleton model when difference data indicating a difference between the first skinned skeleton model and a target skinned skeleton model does not meet a threshold condition on difference data, until a second skinned skeleton model, the difference data between which model and the target skinned skeleton model meets the condition on difference data, is obtained; and
performing at least one deformation on the initial skinned skeleton model based on the target skeletal driving coefficient, to obtain the second skinned skeleton model.

According to a third aspect of the present disclosure, an apparatus for determining a skeletal driving coefficient is provided, where the apparatus includes:
a first deformation module configured to drive, based on a pre-configured initial skeletal driving coefficient, a pre-configured initial skinned skeleton model to be transformed to obtain a first skinned skeleton model; and
a second deformation module configured to: when difference data indicating a difference between the first skinned skeleton model and a target skinned skeleton model does not meet a threshold condition on difference data, perform at least one deformation on the first skinned skeleton model until a second skinned skeleton model, the difference data between which model and the target skinned skeleton model meets the condition on difference data, is obtained, and obtain at least one target skeletal driving coefficient used for driving the at least one deformation.

According to a fourth aspect of the present disclosure, an apparatus for generating a human face model is provided, where the apparatus includes:
a skeletal driving coefficient receiving module configured to receive a target skeletal driving coefficient sent by a server, where the target skeletal driving coefficient is obtained after the server drives a deformation, based on a pre-configured initial skeletal driving coefficient, on a pre-configured initial skinned skeleton model to obtain a first skinned skeleton model, and performs at least one deformation on the first skinned skeleton model when difference data indicating a difference between the first skinned skeleton model and a target skinned skeleton model does not meet a threshold condition on difference data, until a second skinned skeleton model, the difference data between which model and the target skinned skeleton model meets the condition on difference data, is obtained; and
a human face model generation module configured to perform at least one deformation on the initial skinned skeleton model based on the target skeletal driving coefficient, to obtain the second skinned skeleton model.

According to a fifth aspect of the present disclosure, an electronic device is provided, where the electronic device includes:
at least one processor; and
a memory communicatively connected to the at least one processor, where
the memory stores instructions executable by the at least one processor, and when executed by the at least one processor, the instructions cause the at least one processor to perform the method described above.

According to a sixth aspect of the present disclosure, a non-transitory computer-readable storage medium storing computer instructions is provided, where the computer instructions are used to cause a computer to perform the method described above.

According to a seventh aspect of the present disclosure, a computer program product is provided, the computer program including a computer program, where when the computer program is executed by a processor, the method described above is implemented.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE SEVERAL VIEWS OF THE DRAWINGS

The accompanying drawings are used to better understand the solution, and do not constitute a limitation on the present disclosure. In the accompanying drawings:

FIG. 1 is a schematic flowchart of a method for determining a skeletal driving coefficient according to an embodiment of the present disclosure;

FIG. 2 is a schematic structural diagram of a system for generating a human face model according to an embodiment of the present disclosure;

FIG. 3 is a schematic flowchart of a method for generating a human face model according to an embodiment of the present disclosure;

FIG. 4 is a schematic structural diagram of an apparatus for determining a skeletal driving coefficient according to an embodiment of the present disclosure;

FIG. 5 is a schematic structural diagram of an apparatus for generating a human face model according to an embodiment of the present disclosure; and

FIG. 6 is a block diagram of an electronic device configured to implement a method according to an embodiment of the present disclosure.

### DETAILED DESCRIPTION

Example embodiments of the present disclosure are described below in conjunction with the accompanying drawings, where various details of the embodiments of the present disclosure are included to facilitate understanding, and should only be considered as examples. Therefore, those of ordinary skill in the art should recognize that various changes and modifications can be made to the embodiments described here without departing from the scope and spirit of the present disclosure. Likewise, for clarity and conciseness, description of well-known functions and structures are omitted in the following descriptions.

At present, generally, in generation of a 3D human face model corresponding to a photo of a human face, a plurality of blendshape models are generally pre-configured. A blendshape coefficient corresponding to respective blendshape model are generated. Each blendshape model are weighted, by a server, based on each blendshape coefficient, obtaining a 3D human face model corresponding to the photo of the human face.

As an example, the 3D human face model corresponding to the photo of the human face may be generated according to formula 1:

Shape=base+a₁×(bs₁−base)+a₂×(bs₂−base)+a₃×(bs₃−base)+ . . . aₙ×(bsₙ−base) (1),

Here, Shape Shape represents the 3D human face model corresponding to the photo of the human face, base base represents a 3D human face model corresponding to an average face, bs1bs1, bs2bs2, bs3bs3, and bs4bsₙ are all blendshape models, alai is a blendshape coefficient corresponding to bs1bs1, a2a2 is a blendshape coefficient corresponding to bs2bs2, a3a3 is a blendshape coefficient corresponding to bs3bs3, and a4aₙ a4 is a blendshape coefficient corresponding to bs4bsₙ, and n is a positive integer.

In actual use, the server sends a group of blendshape coefficients including a1a1, a2, a3a2, a3, and a4 to an electronic device, so that the electronic device generates the 3D human face model based on the blendshape coefficients.

Because there is a relatively large data amount of the blendshape coefficients (which is generally of several hundred kilobytes (KB)), there are relatively high data transmission costs in a process of sending the blendshape coefficients to the electronic device by the server.

A method and an apparatus for determining a skeletal driving coefficient, an electronic device, and a readable storage medium provided in the embodiments of this application are intended to solve at least one of the above technical problems in the related arts.

FIG. 1 is a schematic flowchart of a method for determining a skeletal driving coefficient according to an embodiment of the present disclosure. As shown in FIG. 1, the method may be applied to a server, and the method may mainly include:
step S110: driving a deformation, based on a pre-configured initial skeletal driving coefficient, on a pre-configured initial skin-skeleton model to obtain a first skinned skeleton model; and
step S120: if difference data between the first skinned skeleton model and a target skinned skeleton model, e.g., data on a difference between the first skinned skeleton model and the target skinned skeleton model, does not meet a threshold condition on difference data, performing at least one deformation on the first skinned skeleton model until a second skinned skeleton model is obtained, where the difference between the obtained second skinned skeleton model and the target skinned skeleton model meets the condition on difference data, and obtaining at least one target skeletal driving coefficient used for driving the at least one deformation.

In some implementations, the difference data is obtained by comparing the first skinned skeleton model and a target skinned skeleton model. The comparison may be conducted on a set of parameters of each model selected for the comparison, e.g., skin vertices of the models.

The target skinned skeleton model may be a 3D human face model generated by a server based on a facial image, which facial image may be sent by an electronic device that requires the 3D human face model to the server.

The initial skinned skeleton model may be pre-configured in the server. The initial skeletal driving coefficient is used to drive a first deformation on the initial skinned skeleton model to obtain the first skinned skeleton model.

A skinned skeleton model includes a plurality of skeleton joints. Skeleton joints can be driven by a skeletal driving coefficient for rigid transformation, namely, translation, rotation, or scaling. Joints in the skinned skeleton model are covered by skins. Each joint has a skin area, which skin area includes a plurality of mesh vertices. Each mesh vertex is controlled by one or more joints.

W. When a skeleton joint is rigidly transformed, the position of the mesh vertex changes accordingly.

A skeletal driving coefficient generally includes nine values, namely, three translation values, three Euler angle rotation values, and three scaling values respectively corresponding to an x-coordinate, a y-coordinate, and a z-coordinate. The initial skeletal driving coefficient may be pre-configured based on actual requirements.

Difference data can represent a difference between two skinned skeleton models, and a degree of a difference between the two skinned skeleton models may be determined by configuring a condition on difference data.

In some implementations, if difference data between two skinned skeleton models meets a threshold condition on difference data, indicating a relatively small difference between the two skinned skeleton models, the two skinned skeleton models may be considered similar. If difference data between two skinned skeleton models does not meet a threshold condition on difference data, the difference between the two skinned skeleton models is indicated to be relatively large. It should be noted that a threshold condition can be determined or set in various ways, which are all included in the scope of the disclosure. For example, a threshold condition or another threshold value may be preset, predetermined, dynamically set, dynamically determined, may be set or determined through training in machine learning, or may be determined or set based on experiment data.

In embodiments of the present disclosure, the first skinned skeleton model is obtained through a first deformation of the initial skinned skeleton model based on the initial skeletal driving coefficient. Generally, when difference data between the first skinned skeleton model and the target skinned skeleton model does not meet the threshold condition on difference data, that is, the difference between the first skinned skeleton model and the target skinned skeleton model is relatively large, at least one iterative deformation may be performed on the first skinned skeleton model until difference data between an skinned skeleton model obtained by iterative deformations and a target skinned skeleton model meets the condition on difference data, i.e., until a second skinned skeleton model having little difference from the target skinned skeleton model is obtained.

In embodiments of the present disclosure, after the second skinned skeleton model is determined through the at least one deformation of the first skin-skeleton, a target skeletal driving coefficient(s) used for driving of the deformation(s) may be obtained. The server may return the target skeletal driving coefficient(s) to the electronic device, and the electronic device may perform, based on the target skeletal driving coefficient, iterative deformation(s) on the initial skinned skeleton model, to finally obtain the second skinned skeleton model, such that the second skinned skeleton model is used as the 3D human face model corresponding to the facial image.

In embodiments of the present disclosure, a data amount of the target drive coefficient(s) for driving the respective iterative deformations is generally of several kilobytes (KB), far less than a data amount of blendshape coefficients in the related arts. Therefore, when a 3D human face model needs to be generated, the server sends the target drive coefficient(s) to the electronic device. The amount of transmitted data is less than that of sending the blendshape coefficients by a server to an electronic device in the related arts, and data transmission costs can be reduced.

According to a method of embodiments of the present disclosure, by driving, based on the pre-configured initial skeletal driving coefficient, to deform the pre-configured initial skinned skeleton model, a skinned skeleton model is obtained. If difference data between the first skinned skeleton model and the target skinned skeleton model does not meet the threshold condition on difference data, at least one deformation is performed on the first skinned skeleton model a second skinned skeleton model, the difference data between which model and the target skinned skeleton model meets the condition on difference data, is obtained; and the target skeletal driving coefficient used for driving the at least one deformation is obtained. Based on this solution, the target skeletal driving coefficient can be returned to the electronic device, to provide a basis for the electronic device to generate the 3D human face model based on the target skeletal driving coefficient. Because a data amount of the target skeletal driving coefficient is relatively small, costs of data transmission between the server and the electronic device can be reduced.

In an implementation of the present disclosure, the performing at least one deformation on the first skinned skeleton model until a second skinned skeleton model, the difference data between which model and the target skinned skeleton model meets the condition on difference data, is obtained includes:
determining a target skeletal driving coefficient based on difference data between a directly previous first skinned skeleton mode and the current first skinned skeleton model and difference data between the first skinned skeleton model and the target skinned skeleton model;
driving a deformation, based on the target skeletal driving coefficient, on the first skinned skeleton model, and determining whether a second skinned skeleton model, the difference data between which model and the target skinned skeleton model meets the condition on difference data, can be obtained through the deformation on the first skinned skeleton model; and
if the second skinned skeleton model has not been obtained, performing the following steps, iteratively, until the second skinned skeleton model, the difference data between which model and the target skinned skeleton model meets the condition on difference data, is obtained: regarding the deformed first skinned skeleton model as the current first skinned skeleton model, determining a target skeletal driving coefficient based on difference data between a directly previous first skinned skeleton mode and the current first skinned skeleton model and difference data between the current first skinned skeleton model and the target skinned skeleton model, driving a deformation, based on the target skeletal driving coefficient, on the first skinned skeleton model, and determining whether the second skinned skeleton model, the difference data between which model and the target skinned skeleton model meets the condition on difference data, is obtained after the deformation is driven on the current first skinned skeleton model.

In embodiments of the present disclosure, when a target skeletal driving coefficient is used for driving a deformation on the first skinned skeleton model, the target skeletal driving coefficient may be determined based on difference data between a directly previous first skinned skeleton mode and the current first skinned skeleton model (namely, difference data between the initial skinned skeleton model and the first skinned skeleton model) and difference data between the first skinned skeleton model and the target skinned skeleton model.

If difference data between the deformed first skinned skeleton model and the target skinned skeleton model meets the condition on difference data, i.e., the difference between the deformed first skinned skeleton model and the target skinned skeleton model is relatively small, the deformed first skinned skeleton model may be determined as the second skinned skeleton model, and the iterative deformation(s) is stopped.

If difference data between the deformed first skinned skeleton model and the target skinned skeleton model does not meet the condition on difference data, i.e., the difference between the deformed first skinned skeleton model and the target skinned skeleton model is relatively large, iterative deformation(s) may be performed on the deformed first skinned skeleton model, i.e., the deformed first skinned skeleton model is used as a first skinned skeleton model, and the following steps may be performed repeatedly until the second skinned skeleton model, the difference data between which model and the target skinned skeleton model meets the condition on difference data, is obtained: regarding the deformed first skinned skeleton model as the current first skinned skeleton model, determining a target skeletal driving coefficient, driving a deformation, based on the target skeletal driving coefficient, on the first skinned skeleton model, and determining whether a difference between the deformed first skinned skeleton model and the target skinned skeleton model is relatively small.

In embodiments of the present disclosure, skinned skeleton models obtained by a plurality of iterative deformations gradually approach the target skinned skeleton model until a second skinned skeleton model having little difference from the target skinned skeleton model is obtained.

In an implementation of the present disclosure, the determining a target skeletal driving coefficient based on difference data between a directly previous first skinned skeleton mode and the current first skinned skeleton model and difference data between the first skinned skeleton model and the target skinned skeleton model includes:
constructing a first matrix based on difference data between a directly previous first skinned skeleton mode and the current first skinned skeleton model;
constructing a second matrix based on difference data between the first skinned skeleton model and the target skinned skeleton model;
constructing an equation based on the first matrix and the second matrix; and
solving the equation based on a pre-configured constraint condition of the target skeletal driving coefficient, to obtain the target skeletal driving coefficient.

In embodiments of the present disclosure, the first matrix may be constructed to represent difference data before and after the first skinned skeleton model, and the second matrix may be constructed to represent difference data between the first skinned skeleton model and the target skinned skeleton model.

As an example, the initial skinned skeleton model includes n mesh vertices, where each mesh vertex includes a total of three coordinate values of an x-coordinate, a y-coordinate, and a z-coordinate, and the n mesh vertices include a total of 3n coordinate values. The initial skinned skeleton model includes m skeleton joints, where each skeleton joint includes three translation values, three Euler angle rotation values, and three scaling values corresponding to the x-coordinate, the y-coordinate, and the z-coordinate respectively, which are a total of nine degrees of freedom. M skeleton joints correspond to a total of 9 m degrees of freedom.

In construction of a matrix used to represent difference data, a subtraction operation may be performed on coordinates of mesh vertices respectively corresponding to two skinned skeleton models, obtaining 3n coordinate difference values; and a subtraction operation may be performed on coordinates of skeleton joints respectively corresponding to the skinned skeleton models, obtaining 9 m coordinate difference values, thereby constructing a matrix with 3n rows and 9 m columns.

In embodiments of the present disclosure, the equation may be constructed based on the first matrix and the second matrix, and the target skeletal driving coefficient may be obtained by solving the equation based on the pre-configured constraint condition of the target skeletal driving coefficient.

As an example, the equation constructed based on the first matrix and the second matrix may be as shown in formula 2:

Ax=B (2),

where, A represents the first matrix, B represents the second matrix, and x represents the target skeletal driving coefficient.

Solving the equation, i.e., having solved a constraint equation set under the constraint of the constraint condition, may turn into a quadratic programming problem with constraints, and therefore, a classic method (for example, the Lagrangian method) is used for solving, which is equivalent to solving min. (Ax−b)T×(Ax−b).

In an implementation of the present disclosure, the target skeletal driving coefficient includes: a target rotation coefficient, a target translation coefficient, and a target scaling coefficient, where the constraint condition includes at least one of the following:
a first value range of the target rotation coefficient;
a second value range of the target translation coefficient; and
a third value range of the target scaling coefficient.

In embodiments of the present disclosure, the constraint condition may be a value range of the target skeletal driving coefficient, and the first value range, the second value range, and the third value range may be specified by a designer based on actual experience. For example, the first value range of the target rotation coefficient is set to be greater than 10° and less than 50°.

In an implementation of the present disclosure, the condition on difference data includes:
a distance between skin vertices respectively corresponding to skinned skeleton models before and after deformation is not greater than a threshold value.

In embodiments of the present disclosure, distances between corresponding skin vertices in a skinned skeleton model obtained through a deformation and the target skinned skeleton model are compared one by one, and the condition on difference data may be set as that a distance between skin vertices corresponding to each other is not greater than the threshold value, thereby ensuring similarity between the two skinned skeleton models while the condition on difference data is met.

As an example, the distance between the skin vertices corresponding to each other may be calculated based on coordinates of the skin vertices, where the distance may be a Euclidean distance.

In an implementation of the present disclosure, the method further includes:
sending the target skeletal driving coefficient to the electronic device to cause the electronic device to perform at least one deformation on the initial skinned skeleton model based on the target skeletal driving coefficient, to obtain the target skinned skeleton model.

In embodiments of the present disclosure, the server may return the target skeletal driving coefficient to the electronic device. The electronic device may have the initial skinned skeleton model stored therein. Iterative deformation(s) is performed on the initial skinned skeleton model based on the target skeletal driving coefficient, to finally obtain the second skinned skeleton model, such that the second skinned skeleton model is used as the 3D human face model corresponding to the facial image.

In actual use, the initial skeletal driving coefficient may be pre-stored in the electronic device, or may be sent to the electronic device with the target skeletal driving coefficient.

As an example, the electronic device may acquire a facial image of a user, and then send the facial image to the server. The server generates the target skinned skeleton model based on the facial image, and then generates the above target skeletal driving coefficient and returns the target skeletal driving coefficient to the electronic device. The electronic device performs iterative deformation(s) on the initial skinned skeleton model based on the target skeletal driving coefficient, to finally obtain the second skinned skeleton model.

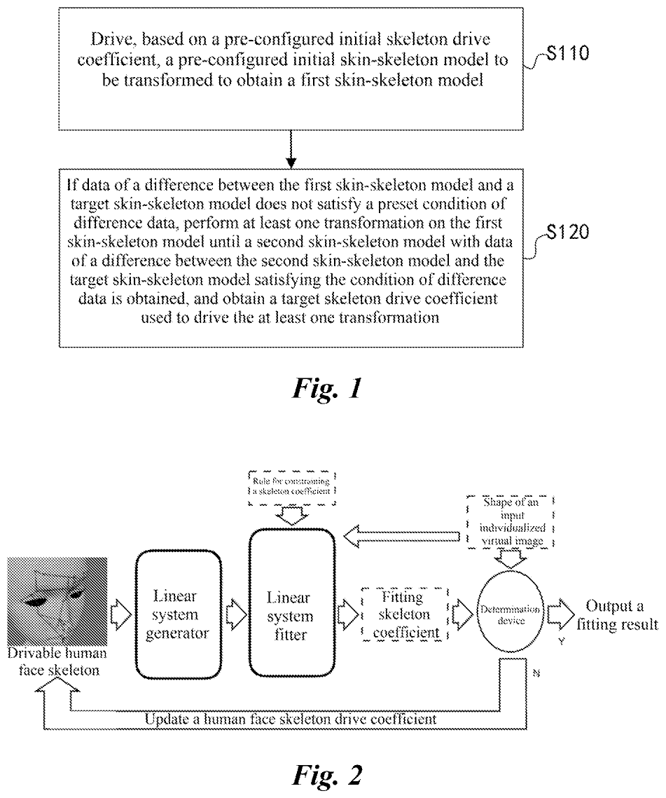

As an example, FIG. 2 is a schematic structural diagram of a system for generating a human face model according to an embodiment of the present disclosure.

FIG. 2 shows a drivable human face skeleton, i.e., an initial skinned skeleton model. Input shape of an individualized avatar is a target skinned skeleton model. Rules for constraining a skeleton coefficient are constraint conditions of a target skeletal driving coefficient.

A linear system generator is used to drive deformations of the initial skinned skeleton model and a first skinned skeleton model based on a skeleton drive system.

A linear system fitter is used to: after obtaining of a deformed skinned skeleton model, solve an equation constructed based on difference data, to obtain a skeletal driving coefficient used to drive a next iterative deformation.

A human face skeletal driving coefficient is updated, i.e., the skeletal driving coefficient used to drive the next iterative deformation is calculated, and the skeletal driving coefficient is provided to the linear system generator for the next iterative deformation.

A determinator is used to determine whether difference data between a deformed skinned skeleton model and the target skinned skeleton model meets a condition on difference data. When the difference data between a deformed skinned skeleton model and the target skinned skeleton model meets the condition on difference data, the difference between a deformed skinned skeleton model and the target skinned skeleton model may be considered relatively small. In this case, the iterative deformation may end, and then a fitting result is output, where the fitting result is the target skeletal driving coefficient. When the difference data between a deformed skinned skeleton model and the target skinned skeleton model does not meet a condition on difference data, the difference between a deformed skinned skeleton model and the target skinned skeleton model may be considered relatively large. In this case, the iterative deformation(s) may be performed on a deformed skinned skeleton model, and whether the difference data between a deformed skinned skeleton model and the target skinned skeleton model meets the condition on difference data is determined.

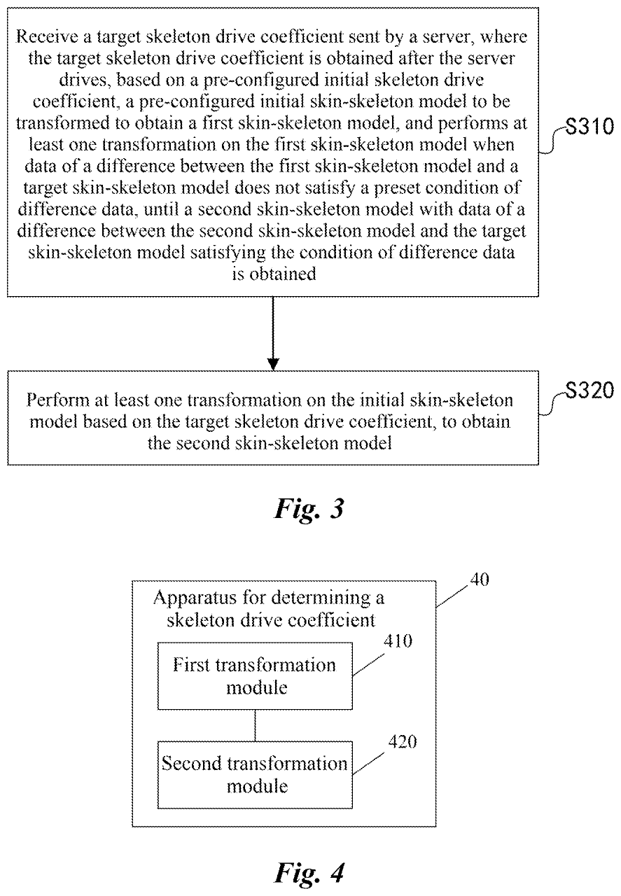

FIG. 3 is a schematic flowchart of another method for determining a skeletal driving coefficient according to an embodiment of the present disclosure. As shown in FIG. 3, the method may be applied to an electronic device, and the method may mainly include:
step S310: receiving a target skeletal driving coefficient sent by a server, where the target skeletal driving coefficient is obtained after the server drives a deformation, based on a pre-configured initial skeletal driving coefficient, on a pre-configured initial skinned skeleton model to obtain a first skinned skeleton model, and performs at least one deformation on the first skinned skeleton model when difference data indicating a difference between the first skinned skeleton model and a target skinned skeleton model does not meet a threshold condition on difference data, until a second skinned skeleton model, the difference data between which model and the target skinned skeleton model meets the condition on difference data, is obtained; and
step S320: performing at least one deformation on the initial skinned skeleton model based on the target skeletal driving coefficient, to obtain the second skinned skeleton model.

The target skinned skeleton model may be a 3D human face model generated by the server based on a facial image, and the facial image may be sent by an electronic device that requires the 3D human face model to the server. The server may determine the target skeletal driving coefficient, and then sends the target skeleton coefficient to the electronic device.

The server may pre-configure the initial skinned skeleton model The initial skeletal driving coefficient is used to drive a first deformation on the initial skinned skeleton model, to obtain the first skinned skeleton model.

A skinned skeleton model includes a plurality of skeleton joints, and the skeleton joints can be driven by a skeletal driving coefficient for rigid deformation, namely, translation, rotation, or scaling. Joints in the skinned skeleton model are covered by skins. Each joint has a skin area, which skin area includes a plurality of mesh vertices. Each mesh vertex is controlled by one or more joints. When the skeleton joint is rigidly transformed, a position of the mesh vertex changes accordingly.

A skeletal driving coefficient generally includes nine values, namely, three translation values, three Euler angle rotation values, and three scaling values respectively corresponding to an x-coordinate, a y-coordinate, and a z-coordinate. The initial skeletal driving coefficient may be pre-configured based on actual requirements.

Difference data can represent a difference between two skinned skeleton models, and a degree of a difference between the two skinned skeleton models may be determined by configuring a condition on difference data.

In some implementations, if difference data between two skinned skeleton models meets a threshold condition on difference data, indicating a relatively small difference between the two skinned skeleton models, the two skinned skeleton models may be considered similar. If difference data between two skinned skeleton models does not meet a threshold condition on difference data, the difference between the two skinned skeleton models is indicated to be relatively large.

In embodiments of the present disclosure, the first skinned skeleton model is obtained through a first deformation of the initial skinned skeleton model based on the initial skeletal driving coefficient. Generally, when difference data between the first skinned skeleton model and the target skinned skeleton model does not meet the threshold condition on difference data, i.e., the difference between the first skinned skeleton model and the target skinned skeleton model is relatively large, at least one iterative deformation(s) may be performed on the first skinned skeleton model until difference data between an skinned skeleton model obtained by iterative deformations and a target skinned skeleton model meets the condition on difference data, i.e., until a second skinned skeleton model having little difference from the target skinned skeleton model is obtained.

In embodiments of the present disclosure, after the server determines the second skinned skeleton model through the at least one deformation of the first skin-skeleton, the target skeletal driving coefficient(s) used for driving of the deformation(s) may be obtained. The server may return the target skeletal driving coefficient(s) to the electronic device, and the electronic device may perform iterative deformation(s) on the initial skinned skeleton model based on the target skeletal driving coefficient, to finally obtain the second skinned skeleton model, such that the second skinned skeleton model is used as the 3D human face model corresponding to the facial image.

The electronic device may store the initial skinned skeleton model. An iterative deformation(s) is performed on the initial skinned skeleton model based on the target skeletal driving coefficient, to finally obtain the second skinned skeleton model, such that the second skinned skeleton model is used as the 3D human face model corresponding to the facial image.

In actual use, the initial skeletal driving coefficient may be pre-stored in the electronic device, or may be sent to the electronic device with the target skeletal driving coefficient.

In embodiments of the present disclosure, a data amount of the target drive coefficient(s) for driving the respective iterative deformations is generally of several kilobytes (KB), far less than a data amount of blendshape coefficients in the related arts. Therefore, when a 3D human face model needs to be generated, the server sends the target drive coefficient(s) to the electronic device, and an amount of transmitted data is less than that during a server sending the blendshape coefficients to an electronic device in the related arts, such that data transmission costs can be reduced.

According to a method of embodiments of the present disclosure, the target skeletal driving coefficient sent by the server is received, so that at least one deformation is performed on the initial skinned skeleton model based on the target skeletal driving coefficient, to obtain the second skinned skeleton model. In this solution, the electronic device generates the 3D human face model based on the target skeletal driving coefficient after receiving the target skeletal driving coefficient sent by the server. Because a data amount of the target skeletal driving coefficient is relatively small, costs of data transmission between the server and the electronic device can be reduced.

According to some similar concepts as those of the method shown in FIG. 1, FIG. 4 is a schematic structural diagram of an apparatus for determining a skeletal driving coefficient according to an embodiment of the present disclosure. As shown in FIG. 4, the apparatus 40 for determining a skeletal driving coefficient may include:
a first deformation module 410 used to drive, based on a pre-configured initial skeletal driving coefficient, a pre-configured initial skinned skeleton model to be transformed to obtain a first skinned skeleton model; and
a second deformation module 420 used to: when difference data indicating a difference between the first skinned skeleton model and a target skinned skeleton model does not meet a threshold condition on difference data, perform at least one deformation on the first skinned skeleton model until a second skinned skeleton model, the difference data between which model and the target skinned skeleton model meets the condition on difference data, is obtained, and obtain at least one target skeletal driving coefficient used for driving the at least one deformation.

According to the apparatus provided in embodiments of the present disclosure, by driving, based on the pre-configured initial skeletal driving coefficient, to deform the pre-configured initial skinned skeleton model, a skinned skeleton model is obtained. If difference data between the first skinned skeleton model and the target skinned skeleton model does not meet the threshold condition on difference data, at least one deformation is performed on the first skinned skeleton model a second skinned skeleton model, the difference data between which model and the target skinned skeleton model meets the condition on difference data, is obtained; and the target skeletal driving coefficient used for driving the at least one deformation is obtained. Based on this solution, the target skeletal driving coefficient can be returned to the electronic device, to provide a basis for the electronic device to generate the 3D human face model based on the target skeletal driving coefficient. Because a data amount of the target skeletal driving coefficient is relatively small, costs of data transmission between the server and the electronic device can be reduced.

In some implementations, when performing at least one deformation on the first skinned skeleton model a second skinned skeleton model, the difference data between which model and the target skinned skeleton model meets the condition on difference data, is obtained, the second deformation module is, in some implementations, configured to:
determine the target skeletal driving coefficient based on difference data between a directly previous first skinned skeleton mode and the current first skinned skeleton model and difference data between the first skinned skeleton model and the target skinned skeleton model;
drive, based on the target skeletal driving coefficient, the first skinned skeleton model to be transformed, and determine whether a second skinned skeleton model, the difference data between which model and the target skinned skeleton model meets the condition on difference data, can be obtained through the deformation on the first skinned skeleton model; and

if the second skinned skeleton model has not been obtained, use the deformed first skinned skeleton model as the first skinned skeleton model, and repeatedly perform the following steps until the second skinned skeleton model, the difference data between which model and the target skinned skeleton model meets the condition on difference data, is obtained: regarding the deformed first skinned skeleton model as the current first skinned skeleton model, determining a target skeletal driving coefficient based on difference data between a directly previous first skinned skeleton mode and the current first skinned skeleton model and difference data between the current first skinned skeleton model and the target skinned skeleton model, driving a deformation, based on the target skeletal driving coefficient, on the first skinned skeleton model, and determining whether the second skinned skeleton model, the difference data between which model and the target skinned skeleton model meets the condition on difference data, is obtained after the deformation is driven on the current first skinned skeleton model.

In some implementations, when determining a target skeletal driving coefficient based on difference data between a directly previous first skinned skeleton mode and the current first skinned skeleton model and difference data between the current first skinned skeleton model and the target skinned skeleton model, the second deformation module is, in some implementations, configured to:
construct a first matrix based on difference data between a directly previous first skinned skeleton mode and the current first skinned skeleton model;
construct a second matrix based on difference data between the first skinned skeleton model and the target skinned skeleton model;
construct an equation based on the first matrix and the second matrix; and
solve the equation based on a pre-configured constraint condition of the target skeletal driving coefficient, to obtain the target skeletal driving coefficient.

In some implementations, the target skeletal driving coefficient includes: a target rotation coefficient, a target translation coefficient, and a target scaling coefficient, where the constraint condition includes at least one of the following:
a first value range of the target rotation coefficient;
a second value range of the target translation coefficient; and
a third value range of the target scaling coefficient.

In some implementations, the condition on difference data includes:
a distance between skin vertices respectively corresponding to skinned skeleton models before and after deformation is not greater than a threshold value.

In some implementations, the apparatus further includes:
a target skeletal driving coefficient sending module configured to send the target skeletal driving coefficient to the electronic device to cause the electronic device to perform at least one deformation on the initial skinned skeleton model based on the target skeletal driving coefficient, to obtain the target skinned skeleton model.

It can be understood that, the above modules of the apparatus for determining a skeletal driving coefficient in embodiments of the present disclosure have functions for implementing corresponding steps of the method for determining a skeletal driving coefficient according to the embodiment shown in FIG. 1. The functions may be implemented by hardware, or may be implemented by hardware executing corresponding software. The hardware or software includes one or more modules corresponding to the functions. The above modules may be software and/or hardware, and the above modules may be implemented independently, or may be implemented by integrating a plurality of modules. For specific descriptions of the functions of the modules of the apparatus for determining a skeletal driving coefficient, refer to corresponding descriptions of the method for determining a skeletal driving coefficient according to the embodiment shown in FIG. 1. Details are not repeated herein.

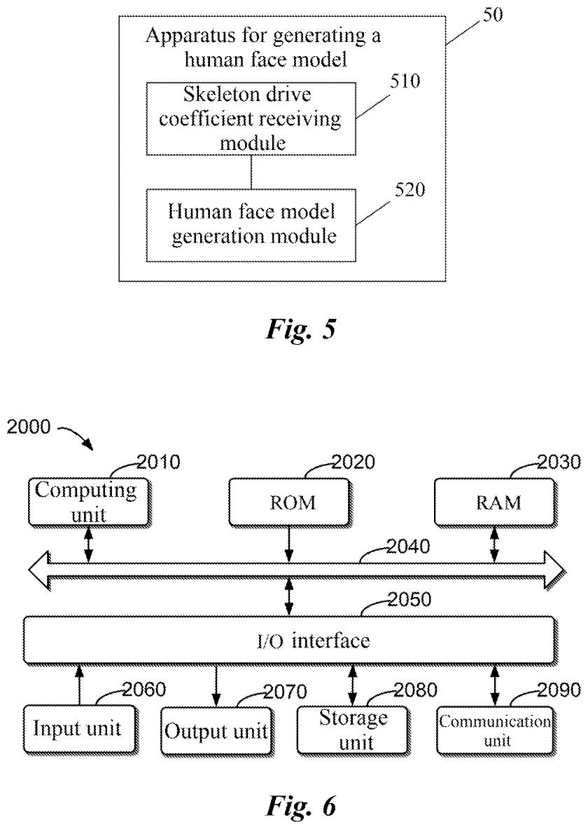

According to some similar concepts as those of the method shown in FIG. 3, FIG. 5 is a schematic structural diagram of an apparatus for generating a human face model according to an embodiment of the present disclosure. As shown in FIG. 5, the apparatus 50 for generating a human face model may include:
a skeletal driving coefficient receiving module 510 configured to receive a target skeletal driving coefficient sent by a server, where the target skeletal driving coefficient is obtained after the server drives a deformation, based on a pre-configured initial skeletal driving coefficient, on a pre-configured initial skinned skeleton model to obtain a first skinned skeleton model, and performs at least one deformation on the first skinned skeleton model when difference data indicating a difference between the first skinned skeleton model and a target skinned skeleton model does not meet a threshold condition on difference data, until a second skinned skeleton model, the difference data between which model and the target skinned skeleton model meets the condition on difference data, is obtained; and
a human face model generation module 520 configured to perform at least one deformation on the initial skinned skeleton model based on the target skeletal driving coefficient, to obtain the second skinned skeleton model.

It can be understood that, the above modules of the apparatus for generating a human face model in embodiments of the present disclosure have functions for implementing corresponding steps of the method for generating a human face model according to the embodiment shown in FIG. 3. The functions may be implemented by hardware, or may be implemented by hardware executing corresponding software. The hardware or software includes one or more modules corresponding to the functions. The above modules may be software and/or hardware, and the above modules may be implemented independently, or may be implemented by integrating a plurality of modules. For specific descriptions of the functions of the modules of the apparatus for generating a human face model, refer to corresponding descriptions of the method for generating a human face model according to the embodiment shown in FIG. 3. Details are not repeated herein.

In the technical solutions of the present disclosure, obtaining, storage, application, etc., of personal information of a user all comply with related laws and regulations and are not against the public order and good morals.

According to an embodiment of the present disclosure, the present disclosure further provides an electronic device, a readable storage medium, and a computer program product.

The electronic device includes: at least one processor; and a memory communicatively connected to the at least one processor, where the memory stores instructions executable by the at least one processor, and when executed by the at least one processor, the instructions cause the at least one processor to perform the method according to the embodiments of the present disclosure.

Compared with one in the related arts, the electronic device drives a pre-configured initial skinned skeleton model to be transformed based on a pre-configured initial skeletal driving coefficient to obtain a first skinned skeleton model, and if difference data indicating a difference between the first skinned skeleton model and a target skinned skeleton model does not meet a threshold condition on difference data, at least one deformation is performed on the first skinned skeleton model until a second skinned skeleton model, the difference data between which model and the target skinned skeleton model meets the condition on difference data, is obtained; and a target skeletal driving coefficient used for driving the at least one deformation is obtained. Based on this solution, the target skeletal driving coefficient can be returned to the electronic device, to provide a basis for the electronic device to generate a 3D human face model based on the target skeletal driving coefficient. Because a data amount of the target skeletal driving coefficient is relatively small, costs of data transmission between a server and the electronic device can be reduced.

The readable storage medium is a non-transitory computer-readable storage medium storing computer instructions, where the computer instructions are used to cause a computer to perform the method according to the embodiments of the present disclosure.

Compared with the related arts, by the readable storage medium, a skinned skeleton model is obtained by driving, based on the pre-configured initial skeletal driving coefficient, to deform the pre-configured initial skinned skeleton model, If difference data between the first skinned skeleton model and the target skinned skeleton model does not meet the threshold condition on difference data, at least one deformation is performed on the first skinned skeleton model a second skinned skeleton model, the difference data between which model and the target skinned skeleton model meets the condition on difference data, is obtained; and the target skeletal driving coefficient used for driving the at least one deformation is obtained. Based on this solution, the target skeletal driving coefficient can be returned to the electronic device, to provide a basis for the electronic device to generate the 3D human face model based on the target skeletal driving coefficient. Because a data amount of the target skeletal driving coefficient is relatively small, costs of data transmission between the server and the electronic device can be reduced.

The computer program product includes a computer program, where when the computer program is executed by a processor, the method according to the embodiments of the present disclosure is implemented.

Compared with the related arts, by the computer program product a skinned skeleton model is obtained by driving, based on the pre-configured initial skeletal driving coefficient, to deform the pre-configured initial skinned skeleton model. If difference data between the first skinned skeleton model and the target skinned skeleton model does not meet a second skinned skeleton model, the difference data between which model and the target skinned skeleton model meets the condition on difference data, is obtained; and the target skeletal driving coefficient used for driving the at least one deformation is obtained. Based on this solution, the target skeletal driving coefficient can be returned to the electronic device, to provide a basis for the electronic device to generate the 3D human face model based on the target skeletal driving coefficient. Because a data amount of the target skeletal driving coefficient is relatively small, costs of data transmission between the server and the electronic device can be reduced.

FIG. 6 is a schematic block diagram of an example electronic device 2000 that can be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 6, the device 2000 includes a computing unit 2010, which may perform various appropriate actions and processing according to a computer program stored in a read-only memory (ROM) 2020 or a computer program loaded from a storage unit 2080 to a random access memory (RAM) 2030. The RAM 2030 may further store various programs and data required for the operation of the device 2000. The computing unit 2010, the ROM 2020, and the RAM 2030 are connected to each other through a bus 2040. An input/output (I/O) interface 2050 is also connected to the bus 2040.

A plurality of components in the device 2000 are connected to the I/O interface 2050, including: an input unit 2060, such as a keyboard or a mouse; an output unit 2070, such as various types of displays or speakers; the storage unit 2080, such as a magnetic disk or an optical disc; and a communication unit 2090, such as a network interface card, a modem, or a wireless communication transceiver. The communication unit 2090 allows the device 2000 to exchange information/data with other devices through a computer network such as the Internet and/or various telecommunications networks.

The computing unit 2010 may be various general-purpose and/or special-purpose processing components with processing and computing capabilities. Some examples of the computing unit 2010 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 2010 performs the method provided in the embodiments of the present disclosure. For example, in some embodiments, the method provided in the embodiments of the present disclosure may be implemented as a computer software program, which is tangibly contained in a machine-readable medium, for example, the storage unit 2080. In some embodiments, a part or all of the computer program may be loaded and/or installed onto the device 2000 via the ROM 2020 and/or the communication unit 2090. When the computer program is loaded onto the RAM 2030 and executed by the computing unit 2010, one or more steps of the method provided in the embodiments of the present disclosure can be performed. Alternatively, in other embodiments, the computing unit 2010 may be configured, by any other suitable means (for example, by means of firmware), to perform the method provided in the embodiments of the present disclosure.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

A program code used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made based on design requirements and other factors. Any modifications, equivalent replacements, improvements, etc., within the spirit and principle of the present disclosure shall fall within the protection scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method for determining a skeletal driving coefficient, comprising:
performing a deformation, based on an initial skeletal driving coefficient, on an initial skin-skeleton model to obtain a first skinned skeleton model; and
in response to a difference between the first skinned skeleton model and a target skinned skeleton model does not meet a threshold, performing at least one deformation on the first skinned skeleton model based on at least one target skeletal driving coefficient until a second skinned skeleton model is obtained, a difference between the second skinned skeleton model and the target skinned skeleton model meeting the threshold.

2. The method according to claim 1, wherein the performing at least one deformation on the first skinned skeleton model until the second skinned skeleton model is obtained comprises:
determining a target skeletal driving coefficient based on a difference between the initial skinned skeleton model and the first skinned skeleton model and the difference between the first skinned skeleton model and the target skinned skeleton model;
performing a first deformation, based on the target skeletal driving coefficient, on the first skinned skeleton model, and determining whether the second skinned skeleton model can be obtained through the first deformation on the first skinned skeleton model; and
in response to it is determined that the second skinned skeleton model has not been obtained, performing following steps, iteratively, until the second skinned skeleton model is obtained:
regarding a deformed first skinned skeleton model obtained through a deformation as a current first skinned skeleton model,
determining a target skeletal driving coefficient based on a difference between an immediately previous first skinned skeleton model and the current first skinned skeleton model and a difference between the current first skinned skeleton model and the target skinned skeleton model,
performing a deformation, based on the target skeletal driving coefficient, on the current first skinned skeleton model, and
determining whether the second skinned skeleton model is obtained after the deformation has been performed on the current first skinned skeleton model.

3. The method according to claim 2, wherein the determining the target skeletal driving coefficient based on the difference between the immediately previous first skinned skeleton mode and the current first skinned skeleton model and the difference between the first skinned skeleton model and the target skinned skeleton model comprises:
constructing a first matrix based on the difference between the immediately previous first skinned skeleton mode and the current first skinned skeleton model;
constructing a second matrix based on the difference between the first skinned skeleton model and the target skinned skeleton model;
constructing an equation based on the first matrix and the second matrix; and
solving the equation based on a constraint condition of the target skeletal driving coefficient, to obtain the target skeletal driving coefficient.

4. The method according to claim 3, wherein the target skeletal driving coefficient comprises: a target rotation coefficient, a target translation coefficient, and a target scaling coefficient, wherein the constraint condition comprises at least one of the following:
a first value range of the target rotation coefficient;
a second value range of the target translation coefficient; and
a third value range of the target scaling coefficient.

5. The method according to claim 1, wherein the threshold comprises:
a distance between skin vertices respectively corresponding to skinned skeleton models before and after deformation is not greater than a threshold value.

6. The method according to claim 1, further comprising:
sending the target skeletal driving coefficient to an electronic device to cause the electronic device to perform at least one deformation on the initial skinned skeleton model based on the target skeletal driving coefficient, to obtain the target skinned skeleton model.

7. A non-transitory computer-readable storage medium storing computer instructions, wherein the computer instructions are used to cause the computer to perform the method according to claim 1.

8. An electronic device, comprising:
at least one processor; and
a memory communicatively connected to the at least one processor, wherein
the memory stores instructions executable by the at least one processor, and when executed by the at least one processor, the instructions cause the at least one processor to perform a method comprising:
performing a deformation, based on an initial skeletal driving coefficient, on an initial skin-skeleton model to obtain a first skinned skeleton model; and
in response to a difference between the first skinned skeleton model and a target skinned skeleton model does not meet a threshold, performing at least one deformation on the first skinned skeleton model based on at least one target skeletal driving coefficient until a second skinned skeleton model is obtained, a difference between the second skinned skeleton model and the target skinned skeleton model meeting the threshold.

9. The electronic device according to claim 8, wherein the performing at least one deformation on the first skinned skeleton model until the second skinned skeleton model is obtained comprises:
determining a target skeletal driving coefficient based on a difference between the initial skinned skeleton model and the first skinned skeleton model and the difference between the first skinned skeleton model and the target skinned skeleton model;
performing a first deformation, based on the target skeletal driving coefficient, on the first skinned skeleton model, and determining whether the second skinned skeleton model can be obtained through the first deformation on the first skinned skeleton model; and
in response to it is determined that the second skinned skeleton model has not been obtained, performing following steps, iteratively, until the second skinned skeleton model is obtained:
regarding a deformed first skinned skeleton model obtained through a deformation as a current first skinned skeleton model,
determining a target skeletal driving coefficient based on a difference between an immediately previous first skinned skeleton model and the current first skinned skeleton model and a difference between the current first skinned skeleton model and the target skinned skeleton model,
performing a deformation, based on the target skeletal driving coefficient, on the current first skinned skeleton model, and
determining whether the second skinned skeleton model is obtained after the deformation has been performed on the current first skinned skeleton model.

10. The electronic device according to claim 9, wherein the determining the target skeletal driving coefficient based on the difference between the immediately previous first skinned skeleton mode and the current first skinned skeleton model and the difference between the first skinned skeleton model and the target skinned skeleton model comprises:
constructing a first matrix based on the difference between the immediately previous first skinned skeleton mode and the current first skinned skeleton model;
constructing a second matrix based on the difference between the first skinned skeleton model and the target skinned skeleton model;
constructing an equation based on the first matrix and the second matrix; and
solving the equation based on a constraint condition of the target skeletal driving coefficient, to obtain the target skeletal driving coefficient.

11. The electronic device according to claim 10, wherein the target skeletal driving coefficient comprises: a target rotation coefficient, a target translation coefficient, and a target scaling coefficient, wherein the constraint condition comprises at least one of the following:
a first value range of the target rotation coefficient;
a second value range of the target translation coefficient; and
a third value range of the target scaling coefficient.

12. The electronic device according to claim 8, wherein the threshold comprises:
a distance between skin vertices respectively corresponding to skinned skeleton models before and after deformation is not greater than a threshold value.

13. A method for generating a human face model, comprising:
receiving a target skeletal driving coefficient sent by a server, wherein the target skeletal driving coefficient is obtained after the server performs a deformation, based on an initial skeletal driving coefficient, on an initial skinned skeleton model to obtain a first skinned skeleton model, and performs at least one deformation on the first skinned skeleton model when difference data indicating a difference between the first skinned skeleton model and a target skinned skeleton model does not meet a threshold condition on difference data until a second skinned skeleton model, the difference data between which model and the target skinned skeleton model meets the condition on difference data, is obtained; and
performing at least one deformation on the initial skinned skeleton model based on the target skeletal driving coefficient, to obtain the target skinned skeleton model.

14. An electronic device, comprising:
at least one processor; and
a memory communicatively connected to the at least one processor, wherein
the memory stores instructions executable by the at least one processor, and when executed by the at least one processor, the instructions cause the at least one processor to perform a method according claim 13.

15. A non-transitory computer-readable storage medium storing computer instructions, wherein the computer instructions are used to cause the computer to perform the method according to claim 13.
